(19) United States
(12) Patent Application Publication
(10) Pub. No.: US 2025/0104268 A1
(43) Pub. Date: Mar. 27, 2025

(54) ELECTRONIC DEVICE FOR DISPLAYING IMAGE AND METHOD FOR OPERATING SAME

(71) Applicant: SAMSUNG ELECTRONICS CO., LTD., Suwon-si (KR)

(72) Inventors: Kyuhyun CHO, Suwon-si (KR); Jinsol PARK, Suwon-si (KR)

(73) Assignee: SAMSUNG ELECTRONICS CO., LTD., Suwon-si (KR)

(21) Appl. No.: 18/977,127

(22) Filed: Dec. 11, 2024

Related U.S. Application Data
(63) Continuation of application No. PCT/KR2023/006324, filed on May 10, 2023.

(30) Foreign Application Priority Data
Jun. 29, 2022 (KR) 10-2022-0079875

(51) Int. Cl. G06T 7/70; G06T 7/55

(52) U.S. Cl. CPC G06T 7/70; G06T 7/55; G06T 2200/08; G06T 2207/20041; G06T 2207/30196

(57) ABSTRACT

An electronic device is disclosed. An electronic device, according to one embodiment of the present disclosure, may include: a memory; and at least one processor electrically connected to the memory, wherein the at least one processor be configured to generate first subject information associated with a first image and second subject information associated with a second image; identify first distance information associated with the first image and second distance information associated with the second image; identify first coordinate information based on the first subject information and the first distance information; identify second coordinate information based on the second subject information and the second distance information; generate first plane information based on the first coordinate information and the second coordinate information; and store the first plane information in the memory.

### CROSS REFERENCES TO RELATED APPLICATION

This application is a continuation of International Application No. PCT/KR2023/006324, filed on May 10, 2023, at the Korean Intellectual Property Office, which claims priority from Korean Patent Application No. 10-2022-0079875, filed on Jun. 29, 2022, at the Korean Intellectual Property Office, the disclosures of which are incorporated herein in their entireties.

### BACKGROUND

### 1. Technical Field

Embodiments of the disclosure relate to an electronic device and operation method for image display.

### 2. Background

Augmented reality (AR) technology may provide VR images that combine real-world images with virtual images. Augmented reality technology may create content that includes additional information that is difficult to obtain in the real world alone, and content created through VR technology may be provided to users through various services, such as advertisements, navigation, and games.

To minimize the sense of incongruity that the user may perceive between virtual images included in a VR image and images of the real world, the images may be arranged based on planes detected in a real-world scene. If the plane is not accurately detected, there is a risk that the augmented reality image may be placed at an incorrect position. To provide an enhanced user experience, the plane may be identified based on the actual image input through the camera. To identify the plane from the obtained image, multiple image sensors or one image sensor and a tilt sensor (e.g., a 6-axis sensor) may be utilized.

### SUMMARY

An electronic device according to an embodiment of the disclosure may include a memory, and at least one processor electrically connected to the memory. The at least one processor may be configured to generate first subject information associated with a first image and second subject information associated with a second image; identify first distance information associated with the first image and second distance information associated with the second image; identify first coordinate information based on the first subject information and the first distance information; identify second coordinate information based on the second subject information and the second distance information; generate first plane information based on the first coordinate information and the second coordinate information; and store the first plane information in the memory.

A method for operating an electronic device according to an embodiment of the disclosure may include generating first subject information associated with a first image and second subject information associated with a second image; identifying first distance information associated with the first image and second distance information associated with the second image; identifying first coordinate information based on the first subject information and the first distance information; identifying second coordinate information based on the second subject information and the second distance information; generating first plane information based on the first coordinate information and the second coordinate information; and storing the first plane information in the memory.

A non-transitory computer readable medium storing one or more instructions, the one or more instructions that, when executed by at least one processor, cause the at least one processor to: generate first subject information associated with a first image and second subject information associated with a second image; identify first distance information associated with the first image and second distance information associated with the second image; identify first coordinate information based on the first subject information and the first distance information; identify second coordinate information based on the second subject information and the second distance information; generate first plane information based on the first coordinate information and the second coordinate information; and store the first plane information in the memory.

### BRIEF DESCRIPTION OF DRAWINGS

FIG. 1 is a block diagram illustrating a configuration of an electronic device according to an embodiment;

FIG. 2 illustrates an example of subject information generated by an electronic device according to an embodiment;

FIG. 3 illustrates an example of plane information generated by an electronic device according to an embodiment;

FIG. 4 illustrates an example of plane information generated by an electronic device according to an embodiment;

FIG. 5 illustrates an operation flow of an electronic device according to an embodiment;

FIG. 6 illustrates an example of generating coordinate information by an electronic device according to an embodiment;

FIG. 7 illustrates an example of providing content by an electronic device according to an embodiment; and

FIG. 8 illustrates an example of providing content by an electronic device according to an embodiment.

In connection with the description of the drawings, the same or similar reference numerals may be used to denote the same or similar elements.

### DETAILED DESCRIPTION

When detecting a plane in an image obtained through a camera included in a display device (e.g., TV, monitor, etc.), since the image sensor is fixed inside the display device, it is necessary to mount multiple cameras or a special camera in the display device. Further, when detecting a plane for an image obtained through an external camera connected to a display device, it is necessary to include a 6-axis sensor in the display device.

Various embodiments of the disclosure may provide an electronic device and an operation method thereof for accurately detecting a plane in an image obtained by a display device without using a separate special camera or multiple image sensors.

Further, there may be provided an electronic device and an operation method thereof for detecting a plane by utilizing a user detection sensor positioned adjacent to a display device.

According to various embodiments of the disclosure, it is possible to detect a plane by utilizing an image sensor and a motion sensor, thereby enabling an enhanced user experience.

Further, according to various embodiments, it is possible to display an image without a sense of incongruity by displaying the subject corresponding to the detected plane.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

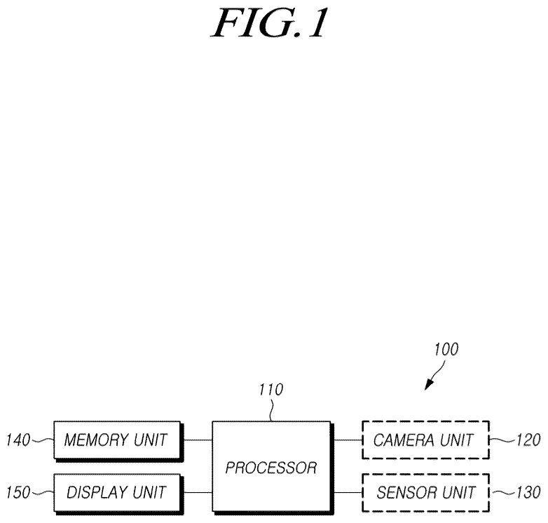

FIG. 1 is a block diagram illustrating a configuration of an electronic device according to an embodiment.

Referring to FIG. 1, an electronic device 100 according to an embodiment includes a device capable of providing augmented reality. The electronic device according to the present invention may be applied to a notebook PC, a desktop PC, a tablet PC, a smart phone, a high definition television (HDTV), a smart TV, a 3-dimensional (3D) TV, an Internet protocol television (IPTV), a home theater, or the like.

The electronic device 100 according to an embodiment may include a processor 110, a camera unit 120, a sensor unit 130, a memory unit 140, and a display unit 150. The block configuration of the electronic device 100 illustrated in FIG. 1 illustrates only components necessary to describe the present invention below. Referring to FIG. 1, the electronic device 100 may not include the camera unit 120 and the sensor unit 130. For example, the camera unit 120 and the sensor unit 130 may include a camera or a sensor connected to the electronic device 100.

The camera unit 120 according to an embodiment may include a lens, an image sensor such as a charged coupled device (CCD), a complementary metal oxide semiconductor (CMOS), and an analog-to-digital converter.

The camera unit 120 according to an embodiment may capture a space in the front direction of the electronic device 100. The camera unit 120 may obtain an image by capturing a space including a subject and a plane. The camera unit 120 may convert the obtained image into a digital signal and transmit the digital signal to the processor 110. The processor 110 described below may process the image converted into the digital signal.

The camera unit 120 according to an embodiment may include an external device connected to the electronic device 100. For example, the camera unit 120 may include an external electronic device (e.g., an external cam, an external camera, another external electronic device including a camera, etc.) that is present separately from the electronic device 100 and is connected to the electronic device 100, rather than a component included in the electronic device 100.

The sensor unit 130 according to an embodiment may include at least one sensor that performs a function of identifying a subject positioned adjacent to the electronic device 100. For example, the sensor unit 130 may include at least one of a motion sensor, a radio frequency (RF) sensor, an ultra-wideband (UWB) sensor, and an ultrasonic sensor.

The sensor unit 130 according to an embodiment may obtain information related to the position of the subject positioned adjacent to the electronic device 100. For example, the sensor unit 130 may obtain information about the distance between the subject and the electronic device 100 and information about the direction. The sensor unit 130 may transmit the obtained information related to the position of the subject to the processor 110. The processor 110 described below may process the received information related to the position of the subject.

The sensor unit 130 according to an embodiment may include an external device connected to the electronic device 100. For example, the sensor unit 130 may include an external sensor present separately from the electronic device 100 and connected to the electronic device 100, rather than a component included in the electronic device 100.

The memory unit 140 according to an embodiment may include at least one type of storage medium of flash memory types, hard disk types, multimedia card micro types, card types of memories (e.g., SD or XD memory cards), random access memories (RAM), static random access memories (SRAM), read-only memories (ROM), electrically erasable programmable read-only memories (EEPROM), programmable read-only memories (PROM), magnetic memories, magnetic disks, or optical discs.

The memory unit 140 according to an embodiment may store an image obtained through the camera unit 120 and information related to the position of the user obtained through the sensor unit 130. Further, the memory unit 140 may store various data for detecting a plane in an image.

The display unit 150 according to an embodiment may display information processed by the processor 110. In an embodiment, the display unit 150 may display an image of a space captured by the camera unit 120. In an embodiment, the display unit 150 may display an augmented reality image in which a virtual image is synthesized with the image of the space.

In an embodiment, the display unit 150 may display a graphic user interface (GUI) related to various functions of the electronic device 100.

In an embodiment, the display unit 150 may include a touch panel to be used as an input device. The display unit 150 may be implemented as a liquid crystal display, a thin film transit-liquid crystal display, an organic light-emitting diode, a flexible display, a 3D display, or the like.

The processor 110 according to an embodiment may generate information about the plane of the captured space, based on the data about the image received from the camera unit 120 and the information about the position of the user received from the sensor unit 130.

In an embodiment, the processor 110 may include an image input unit that receives an image captured from the camera unit 120.

In an embodiment, the processor 110 may include a subject information generation unit generating subject information related to the subject included in the image received through the image input unit.

In an embodiment, the processor 110 may obtain information about the subject based on the received data about the image. The subject may refer to the user positioned adjacent to the electronic device 100. For example, the information about the subject may include information about the area where the subject is positioned, and information about main features of the subject (e.g., the head position, the hand position, the foot end position, the body center position, etc. of the user).

In an embodiment, the processor 110 may include a distance detection unit detecting the distance between the user and the electronic device based on the user position information received through the sensor unit 130.

In an embodiment, the processor 110 may include a coordinate generation unit generating coordinate information about the subject based on the subject information generated by the subject information generation unit and the distance between the user and the electronic device detected by the distance detection unit.

In an embodiment, the processor 110 may include a plane detection unit generating plane information based on the generated coordinate information.

In an embodiment, the processor 110 may determine the position of the subject in the virtual space based on the generated plane information and display the same on the display unit 150.

Although not shown, the electronic device 100 may include a communication unit (not shown) for communicating with a server (not shown) or an external device (not shown). The communication unit (not shown) may receive an image from an external device (not shown) and may transmit and receive data required to detect a plane of the image. The communication unit (not shown) may include a short-range communication unit, a mobile communication unit, and a broadcast receiving unit.

In an embodiment, the short-range communication unit may include, but is not limited to, a Bluetooth communication unit, a Bluetooth low energy (BLE) communication unit, a near field communication unit, a Zigbee communication unit, an infrared data association (IrDA) communication unit, a Wi-Fi direct (WFD) communication unit, an ultra-wideband (UWB) communication unit, an Ant+ communication unit, etc.

In an embodiment, the mobile communication unit may transmit and receive a wireless signal to and from at least one of a base station, an external device, and a server on a mobile communication network. The wireless signals may include voice call signals, video call signals, or other various types of data according to transmission/reception of text/multimedia messages.

In an embodiment, the broadcast receiving unit may receive a broadcast signal and/or broadcast-related information from the outside through a broadcast channel. The broadcast channel may include a satellite channel or a terrestrial channel.

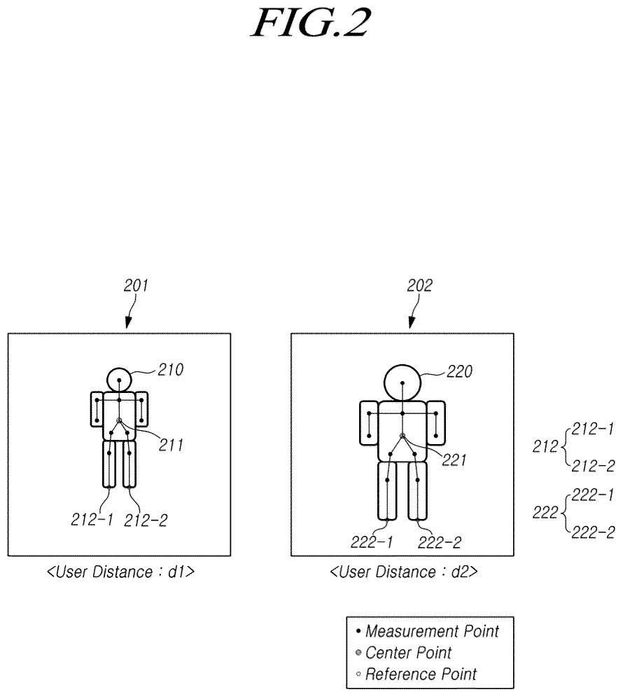

FIG. 2 illustrates an example of subject information generated by an electronic device according to an embodiment.

Referring to FIG. 2, the electronic device 100 may obtain at least two images (e.g., a first image 201 and a second image 202) through the camera unit 120. The electronic device 100 may generate subject information (e.g., pose estimation) based on the obtained image.

In an embodiment, the electronic device 100 may obtain a first image 201 including a first subject 210 and a second image 202 including a second subject 220. The first subject 210 may mean a subject included in the first image 201, and the second subject 220 may mean a subject included in the second image 202.

In an embodiment, the first subject 210 and the second subject 220 may represent objects corresponding to the same user. For example, the first subject 210 may represent a user included in an image captured when the user is at a first position, and the second subject 220 may represent a subject included in an image captured when the user is at a second position. In an embodiment, the first position and the second position may have different coordinate values.

In an embodiment, the first user distance d1 may mean a distance between the first subject 210 and the electronic device 100. In an embodiment, the second user distance d2 may mean a distance between the second subject 220 and the electronic device 100. The first user distance d1 and the second user distance d2 may be obtained through the sensor unit 130 of the electronic device 100.

In an embodiment, the subject information may mean information (e.g., coordinate values or suitable information for identifying relative positions) about a plurality of measurement points (e.g., center point of the subject, position of head, position of feet, etc.) identified for the subject. The electronic device 100 may identify the shape and feature of the subject using learning based on deep learning of the obtained image, and identify a plurality of measurement points corresponding to each shape and feature.

In an embodiment, the plurality of measurement points may mean measurement points corresponding to a plurality of body parts of the subject. For example, the measurement points may mean points corresponding to the positions of the user's neck, shoulders, elbows, fingertips, chest, waist, buttocks, thighs, calves, and foot ends.

In an embodiment, the center point (e.g., the center point 211 or the center point 221) may refer to a point (e.g., the waist) positioned at the center of the subject among the plurality of measurement points. In an embodiment, the center point may mean a point corresponding to the center position of the subject calculated based on at least some of the plurality of measurement points.

In an embodiment, the electronic device 100 may generate position information about the electronic device 100 and the subject with respect to the center point.

In an embodiment, the reference point (e.g., the reference point 221 and the reference point 222) may mean a measurement point (e.g., foot end) closest to the plane among the plurality of measurement points. The reference point 212 may include a first reference point 212-1 corresponding to an end of one foot and a second reference point 212-2 corresponding to an end of the other foot. The reference point 222 may include a first reference point 222-1 corresponding to an end of one foot and a second reference point 222-2 corresponding to an end of the other foot.

In an embodiment, the electronic device 100 may set the position of the subject so that the reference point is positioned on the generated plane.

In an embodiment, the electronic device 100 may obtain first subject information about the first subject 210, based on the first image 201 captured and obtained at a first time. For example, the first subject information may include information about coordinate values of the plurality of measurement points, information about the coordinate value of the center point 211, and information about the coordinate value of the reference point 212.

In an embodiment, the electronic device 100 may obtain second subject information about the second subject 220 based on the second image 202 captured and obtained at a second time. For example, the second subject information may include information about coordinate values of the plurality of measurement points, information about the coordinate value of the center point 221, and information about the coordinate value of the reference point 222.

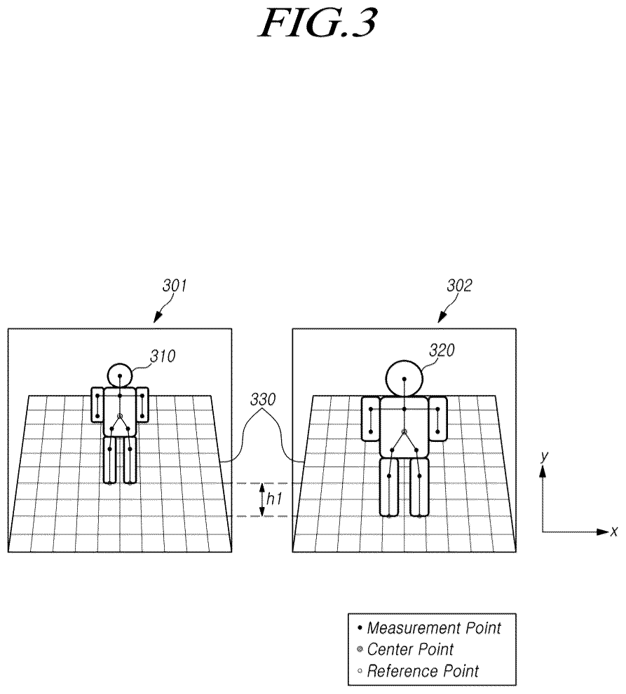

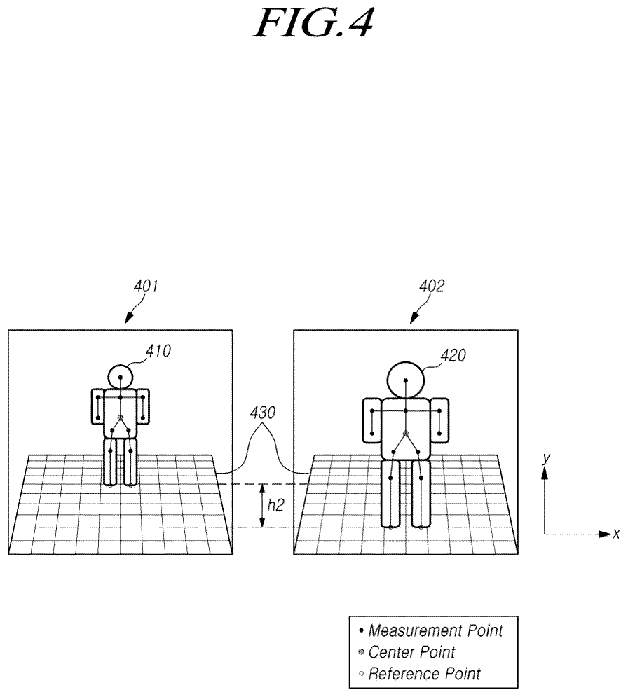

FIG. 3 illustrates an example of plane information generated by an electronic device according to an embodiment. FIG. 4 illustrates another example of plane information generated by an electronic device according to an embodiment.

Referring to FIGS. 3 and 4, a virtual plane generated by the electronic device 100 according to an embodiment may be displayed in the form of a grid having a constant slope. The width and height of one cell of the grid may have a predetermined value (e.g., 0.5 m).

In an embodiment, the electronic device 100 may generate information about one plane based on at least two images. Each of the images may include a subject, and positions of the subjects included in each of the images may be different. For example, the subject included in the images may mean an object corresponding to the same user having different positions.

The electronic device 100 according to an embodiment may generate a virtual plane (e.g., the first plane 330 and the second plane 430) based on the information about the first image and the information about the second image. The matters regarding the first image and the second image described with reference to FIGS. 3 and 4 are the same as those described with reference to FIG. 2.

Referring to FIGS. 3 and 4, there may be a difference in slope between the first plane 330 and the second plane 430. In other words, different plane information may be generated according to the two obtained images.

In an embodiment, the first plane 330 represents a plane generated when the first user distance d1 between the first subject 310 and the electronic device 100 is 5 m and the second user distance d2 between the second subject 320 and the electronic device 100 is 4 m. In an embodiment, the second plane 430 represents a plane generated when the first user distance d1 between the first subject 410 and the electronic device 100 is 5 m and the second user distance d2 between the second subject 420 and the electronic device 100 is 3 m. The above-described numerical values are merely an example, and information about a plane having various values may exist.

In an embodiment, the difference in position (e.g., h1 and h2) between the first subject and the second subject may have a value corresponding to the difference between the first user distance d1 and the second user distance d2. For example, the difference in position between the first subject 310 and the second subject 320 may have a value corresponding to 1 m, which is a difference between d1 and d2. Accordingly, the second subject 320 may be positioned two cells ahead of the first subject 310. Further, e.g., the difference in position between the first subject 410 and the second subject 420 may have a value corresponding to 2 m, which is a difference between d1 and d2. Accordingly, the second subject 420 may be positioned two cells ahead of the first subject 410.

In an embodiment, the electronic device 100 may place the subject so that the reference point of the subject corresponds to the generated plane information. In other words, by placing the subject so that the foot end is positioned on the generated plane, it is possible to display a perspective screen.

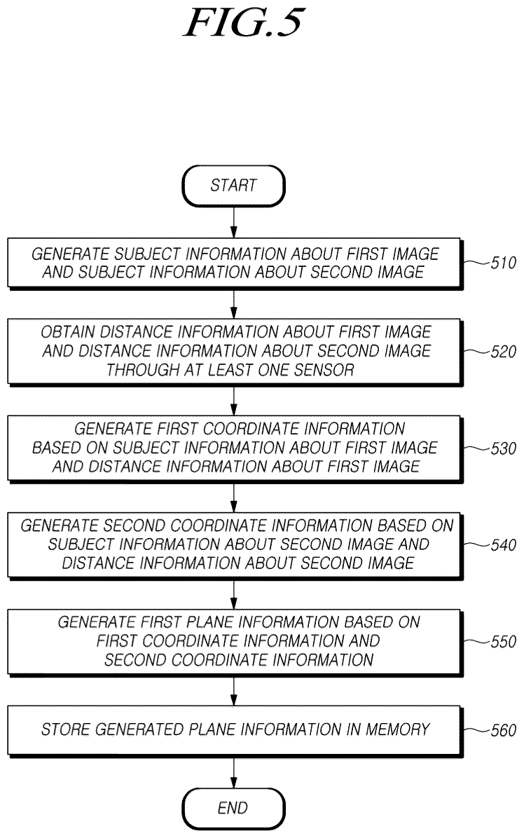

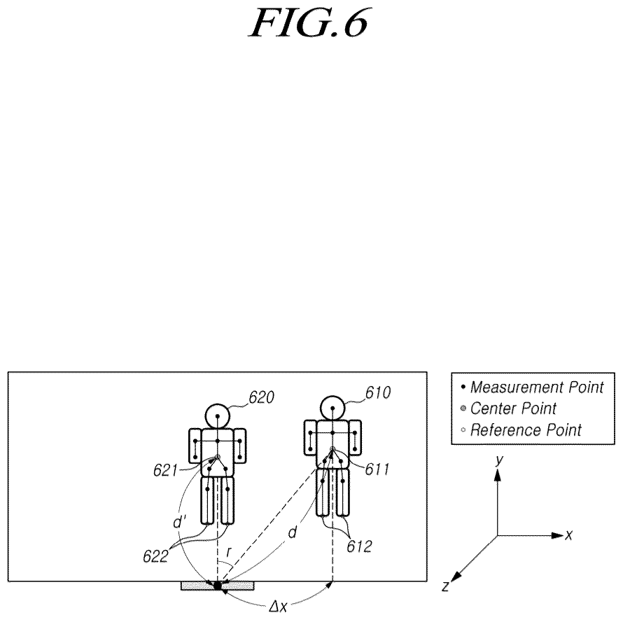

FIG. 5 illustrates an operation flow of an electronic device according to an embodiment. FIG. 6 illustrates an example of generating coordinate information by an electronic device according to an embodiment. The electronic device described with reference to FIGS. 5 and 6 may refer to an electronic device corresponding to the electronic device 100 of FIG. 1. In relation to the terms used in the description of FIGS. 5 and 6, the description of the overlapping or obvious parts with those described above with reference to FIGS. 1, 2, 3, and 4 may be omitted.

According to an embodiment, in operation 510, the electronic device may generate subject information about the first image (e.g., first subject information) and subject information about the second image (e.g., second subject information).

In an embodiment, the electronic device may generate subject information about a subject included in the first image, based on the first image. The electronic device may generate subject information about a subject included in the first image based on the first image input to the camera unit. The electronic device may generate subject information about a subject included in the first image based on the first image obtained through the external device.

In an embodiment, the first image may refer to an image captured through the camera unit at a first time different from the second time, and may include a subject and a background area. In an embodiment, the subject may include the user who controls the electronic device.

In an embodiment, the electronic device may detect the user's pose through an image processing method through machine learning or the like, and may generate information related thereto.

In an embodiment, the subject information about the first image may include information about a plurality of measurement points about the subject included in the first image, information about a center point, and information about measurement points (e.g., a first measurement point and a second measurement point). In an embodiment, the subject information about the first image may include information about coordinate values of the plurality of measurement points, the center point, and the reference point. The coordinate value may include at least one of 1D, 2D, and 3D coordinate values.

In an embodiment, the measurement point may mean a point indicating a component (e.g., a head, a shoulder, an elbow, a hand, a waist, a thigh, a foot end, or the like) of the subject.

In an embodiment, the center point and the reference point may be any one of the plurality of measurement points. In an embodiment, the center point and the reference point may be identified from among a plurality of predetermined measurement points considering the area occupied by the subject and characteristics.

In an embodiment, the center point may mean a point corresponding to the center position of the subject. For example, the center point may mean a point corresponding to the center coordinates among the coordinates of the plurality of identified measurement points. In an embodiment, the center may mean the center in the horizontal direction (x-axis direction) in the image such as the neck, chest, the center of the shoulders, or the center of the buttocks.

In an embodiment, the reference point may mean a point corresponding to the foot, e.g., foot end position of the subject. For example, the reference point may include a point corresponding to the end of the left (−x) foot end and a point corresponding to the end of the right (+x) foot.

In an embodiment, when the measurement point corresponding to the position of the foot, e.g., foot end position, of the subject does not move and does not deviate within a predetermined range for a predetermined time or more, the electronic device may determine the corresponding measurement point as the reference point. For example, when it is identified that the user's foot end being captured is fixed and does not move for one second or longer, the electronic device may determine that the point where the foot end is positioned as the reference point.

In an embodiment, when the distance between the measurement points identified as the positions of the feet, e.g., foot end positions, of the subject is less than or equal to a predetermined value, the electronic device may determine the corresponding measurement points as the first reference point and the second reference point, respectively.

In an embodiment, the electronic device may generate subject information about the second image, based on the second image. The electronic device may generate subject information about the second image based on the second image input to the camera unit. The electronic device may generate subject information about a subject included in the first image based on the first image obtained through the external device.

In an embodiment, the second image may refer to an image captured by the electronic device at the second time through the camera unit. In an embodiment, the operation of generating the subject information about the second image may include an operation corresponding to the operation of generating the subject information about the first image.

According to an embodiment, in operation 520, the electronic device may obtain distance information about the first image (e.g., first distance information) and distance information about the second image (e.g., second distance information) through the at least one sensor.

In an embodiment, the distance information may include information about a distance (hereinafter, referred to as a “subject distance”) between the electronic device and the subject. In an embodiment, the position information may include information about the coordinate value of the position where the subject is present with respect to the electronic device. The coordinate value may be any one of 1D, 2D, or 3D coordinate values.

In an embodiment, the distance between the electronic device and the subject may be determined based on the coordinate value of the subject detected through the motion sensor. Even if the user's position is identified as a 2D and 3D coordinate value, the electronic device may lower the dimension to single data (distance).

According to an embodiment, in operation 530, the electronic device may generate first coordinate information based on subject information about the first image and distance information about the first image. The first coordinate information may mean information about a value obtained by correcting the coordinate value of the subject identified at the first time. The operation of generating coordinate information by the electronic device may be described with reference to FIG. 5.

In an embodiment, the first coordinate information may be generated based on information about the subject direction and the subject distance. The subject direction may have a value corresponding to an angle between the center position of the first image and the center position of the first subject, i.e., the positions of the center points. The subject direction may have a value within the angle of view of the camera unit of the electronic device.

In an embodiment, the corrected user distance may be determined based on the following equation.

$$\begin{matrix}Equation 1 & \\ {d}^{′} = d * cos ( r * Δ x ) & Eqn ( 1 )\end{matrix}$$

In the above equation, d′ may mean the corrected subject distance, d may mean the user distance before correction, r may mean the subject direction, and Δx may mean the value corresponding to the difference in the horizontal direction between the center position 501 of the image and the center position 511 of the subject.

Referring to FIG. 6, the distance between the electronic device and the center position 611 of the subject 610 may correspond to d, the difference in the horizontal direction between the center position 621 of the image and the center position 611 of the subject 610 may be Δx, and the angle formed between the center position 621 of the image and the center position 611 of the subject 610 may mean the subject direction r. When the Cos operation is performed based on the above-described values, the corrected subject distance may be obtained. The electronic device may generate plane information based thereon.

According to an embodiment, in operation 540, the electronic device may generate the second coordinate information based on the subject information and the second distance information about the second image. In an embodiment, operation 540 may include an operation corresponding to operation 530.

According to an embodiment, in operation 550, the electronic device may generate plane information based on the first coordinate information and the second coordinate information. As described above, the first coordinate information may refer to a coordinate value after performing correction according to Equation 1 on the coordinates of the subject at the first time, and the second coordinate information may refer to a coordinate value after performing correction according to Equation 1 on the coordinates of the subject at the second time.

In an embodiment, the first coordinate value included in the first coordinate information and the second coordinate value included in the second coordinate information may have the same x-axis and z-axis coordinate values, and may have different y-coordinates. Since both the x-axis and z-axis components may be equally corrected with respect to the central axis of the electronic device according to the result of the operation performed in Equation 1, only values corresponding to the y-axis coordinate values of the first coordinate value and the second coordinate value may be different.

In an embodiment, the electronic device may determine a vector perpendicular to the line connecting the first coordinates and the second coordinates as a vector in the y-axis direction.

In an embodiment, the electronic device may generate information about the plane using the value of the normal vector and the line connecting the first coordinates and the second coordinates.

According to an embodiment, in operation 560, the electronic device may store the generated plane information in the memory.

In an embodiment, the electronic device may update the plane information by performing the operations of generating subject information, generating distance information, and generating coordinate information for the input image. For example, the electronic device may obtain a third image different from the first image and the second image, may generate subject information about the third image and distance information about the third image, may generate third coordinate information based on the subject information about the third image and the distance information about the third image, may generate second plane information different from the first plane information based on the third coordinate information and the plane information, and may store the second plane information in the memory.

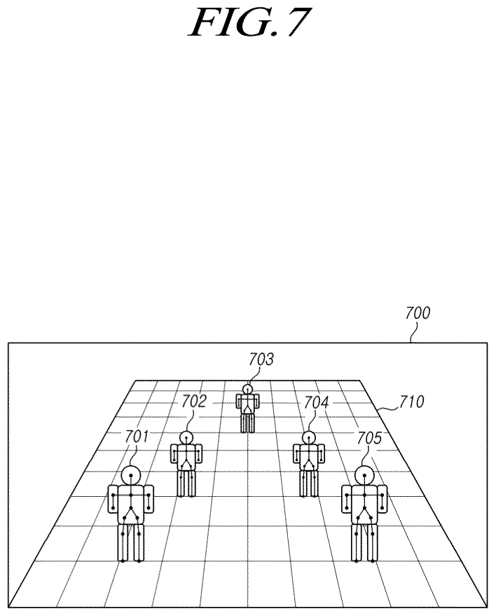

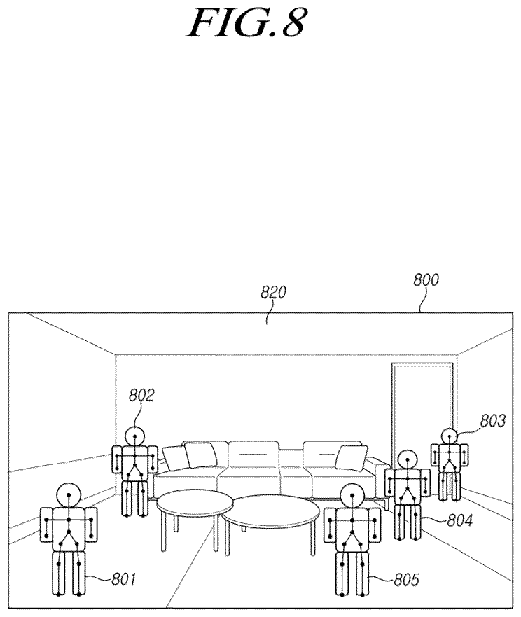

FIG. 7 illustrates an example of providing content by an electronic device according to an embodiment. FIG. 8 illustrates another example of providing content by an electronic device according to an embodiment.

Referring to FIG. 7, the electronic device according to an embodiment may display objects (e.g., a first object 701, a second object 702, a third object 703, a fourth object 704, and a fifth object 705) together with the plane 710, based on the generated plane information. Five objects are illustrated in the drawings, but this is merely an example, and the content provided by the electronic device according to an embodiment may include more or less objects than five objects. The objects shown in FIG. 7 may represent virtual objects.

In an embodiment, the content 700 provided by the electronic device may include at least one object (e.g., the first object 701, the second object 702, the third object 703, the fourth object 704, the fifth object 705) and the plane 710. For example, the electronic device may display the plane 710 in the form of a grid based on the generated plane information.

In an embodiment, the electronic device may match the foot end position of the object to the position of the plane, based on the foot end position of the object and the position of the object.

In an embodiment, the electronic device may adjust the size of the displayed object by applying perspective according to the position of the object to be displayed. For example, the second object 702 and the fourth object 704 positioned further away from the electronic device may be displayed to have a size smaller than that of the first object 701 and the fifth object 705 displayed relatively close thereto. The third object 703 positioned farthest from the electronic device may be displayed to have a size smaller than that of the first object 701, the second object 702, the fourth object 704, and the fifth object 705.

In an embodiment, a plurality of objects included in the content 700 provided by the electronic device may be included. Referring to the content 700 of FIG. 7, the content 700 may include a plurality of objects (e.g., a first object 701, a second object 702, a third object 703, a fourth object 704, and a fifth object 705) and a background image. The plurality of objects displayed on the content 700 may refer to virtual objects, and the background image may include an image actually captured through the camera unit of the electronic device or an image stored in the memory.

In an embodiment, the content provided by the electronic device may omit display of the plane. Referring to FIG. 8, it may be identified that the content 800 omits display of the plane displayed in the form of a grid, unlike the content 700 of FIG. 7. However, similar to the operation of displaying the content 700 of FIG. 7, the electronic device may match the foot end position of the object to the position of the plane based on the foot end position of the object (e.g., the first object 801, the second object 802, the third object 803, the fourth object 804, and the fifth object 805) and the position of the object.

In an embodiment, the electronic device may adjust the size of the displayed object by applying perspective according to the position of the object to be displayed. For example, the second object 802 and the fourth object 804 positioned further away from the electronic device may be displayed to have a size smaller than that of the first object 801 and the fifth object 805 displayed relatively close thereto. The third object 803 positioned farthest from the electronic device may be displayed to have a size smaller than that of the first object 801, the second object 802, the fourth object 804, and the fifth object 805.

An electronic device according to an embodiment of the disclosure may comprise a memory, and at least one processor electrically connected to the memory. The at least one processor may generate subject information about a first image and subject information about a second image, identify distance information about the first image and distance information about the second image, identify first coordinate information based on the subject information about the first image and the distance information about the first image, identify second coordinate information based on the subject information about the second image and the distance information about the second image, generate first plane information based on the first coordinate information and the second coordinate information, and store the generated first plane information in the memory.

In an embodiment, the subject information about the first image and the subject information about the second image may include information about coordinate values of center positions of a subject included in the first image and a subject included in the second image, and information about coordinate values of positions of ends of both feet of the subject included in the first image and the subject included in the second image.

In an embodiment, the at least one processor may determine that the coordinate values of the positions of the ends of the feet of the subject are the subject information about the first image and the subject information about the second image when the positions of the ends of the feet of the subject included in the first image and the subject included in the second image are fixed within a predetermined range for a predetermined time.

In an embodiment, the at least one processor may determine that the coordinate values of the positions of the ends of the feet of the subject are the subject information about the first image and the subject information about the second image when a difference between coordinate values corresponding to the positions of the ends of the feet of the subject included in the first image and the subject included in the second image is a predetermined value or less.

In an embodiment, the subject included in the second image may be identical to the subject included in the first image, and a coordinate value of the subject included in the second image may be different from a coordinate value of the subject included in the first image.

In an embodiment, the distance information about the first image may include a first distance d1 between the electronic device and a center position of the subject included in the first image, and the distance information about the second image may include a second distance d2 between the electronic device and a center position of the subject included in the second image.

In an embodiment, the first coordinate information may include information about an angle r1 between a center position of the first image and the center position of the subject included in the first image and a first corrected distance d1′ determined as the first distance d1 is corrected, and the second coordinate information may include information about an angle r2 between a center position of the second image and the center position of the subject included in the second image and a second corrected distance d2′ determined as the second distance d2 is corrected.

In an embodiment, the at least one processor may determine the first corrected distance d1′ and the second corrected distance d2′ based on an equation below, d′=d*cos(r*Ax). In the equation above, d′ may be a corrected distance, d may be a distance between the electronic device and the subject, r may be an angle between the center of the image and the subject, and Δx may be a distance in a horizontal direction between the center position of the image and the center position of the subject.

In an embodiment, the at least one processor may obtain the first image and the second image from an external image sensor electrically connected to the electronic device.

In an embodiment, the electronic device may further comprise a camera. The at least one processor may obtain the first image and the second image through the camera, and store the obtained first image and second image in the memory.

In an embodiment, the at least one processor may obtain a third image different from the first image and the second image from at least one of the camera or an external image sensor electrically connected to the electronic device, generate subject information about the third image and distance information about the third image, generate third coordinate information based on the subject information about the third image and the distance information about the third image, generate second plane information different from the first plane information based on the third coordinate information and the plane information, and store the second plane information in the memory.

In an embodiment, the electronic device may further comprise a display. The at least one processor may display, on the display, at least one object based on the generated first plane information. A position of an end of a foot of the at least one object may be positioned on a virtual plane defined according to the first plane information.

In an embodiment, the at least one processor may display, on the display, the virtual plane defined based on the first plane information in a grid form.

In an embodiment, the electronic device may further comprise at least one sensor. The at least one processor may identify the distance information about the first image and the distance information about the second image through the at least one sensor, and store the identified first image distance information and second image distance information in the memory.

In an embodiment, the at least one sensor may include at least one of a motion sensor, a radio frequency (RF) sensor, an ultra-wideband (UWB) sensor, and an ultrasonic sensor.

A method for operating an electronic device according to an embodiment of the disclosure may comprise generating subject information about a first image and subject information about a second image, identifying distance information about the first image and distance information about the second image, identifying first coordinate information based on the subject information about the first image and the distance information about the first image, identifying second coordinate information based on the subject information about the second image and the distance information about the second image, generating first plane information based on the first coordinate information and the second coordinate information, and storing the generated first plane information in the memory.

In an embodiment, the subject information about the first image and the subject information about the second image may include information about coordinate values of center positions of a subject included in the first image and a subject included in the second image, and information about coordinate values of positions of ends of both feet of the subject included in the first image and the subject included in the second image.

In an embodiment, the method may further comprise determining that the coordinate values of the positions of the ends of the feet of the subject are the subject information about the first image and the subject information about the second image when the positions of the ends of the feet of the subject included in the first image and the subject included in the second image are fixed within a predetermined range for a predetermined time.

In an embodiment, the method may further comprise determining the coordinate values of the positions of the ends of the feet of the subject as a reference point when a difference between coordinate values corresponding to the positions of the ends of the feet of the subject is a predetermined value or less.

In an embodiment, the subject included in the second image may be identical to the subject included in the first image, and a coordinate value of the subject included in the second image may be different from a coordinate value of the subject included in the first image.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device 100 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
memory; and
at least one processor electrically connected to the memory, wherein the at least one processor is configured to:
generate first subject information associated with a first image and second subject information associated with a second image;
identify first distance information associated with the first image and second distance information associated with the second image;
identify first coordinate information based on the first subject information and the first distance information;
identify second coordinate information based on the second subject information and the second distance information;
generate first plane information based on the first coordinate information and the second coordinate information; and
store the first plane information in the memory.

2. The electronic device of claim 1, wherein the first subject information and the second subject information comprises:
information associated with coordinate values of center position of a first subject included in the first image and information associated with the coordinate values of the center position of a second subject included in the second image; and
information associated with coordinate values of positions of at least one foot of the first subject and information associated with the coordinate values of the positions of at least one foot of the second subject.

3. The electronic device of claim 2, wherein the at least one processor is further configured to:
determine, when the positions of at least one foot of the first subject and the second subject are fixed within a predetermined range for a predetermined time, that the coordinate values of the positions of at least one foot of the first subject are the first subject information and the coordinate values of the positions of at least one foot of the second subject are the second subject information.

4. The electronic device of claim 2, wherein the at least one processor is further configured to:
determine, when a difference between coordinate values of the positions of both feet of the first subject is a predetermined value or less, that the coordinate values of the positions of the feet of the first subject are the first subject information, and determine, when a difference between coordinate values of both feet of the second subject is a predetermined value or less, that the coordinate values of the positions of the feet of the second subject are the second subject information.

5. The electronic device of claim 2, wherein the second subject is identical to the first subject, and
wherein a coordinate value of the second subject is different from a coordinate value of the first subject.

6. The electronic device of claim 2, wherein the first distance information comprises a first distance between the electronic device and the center position of the first subject, and the second distance information comprises a second distance between the electronic device and the center position of the second subject.

7. The electronic device of claim 6, wherein the first coordinate information comprises information about a first angle between a center position of the first image and the center position of the first subject and a first corrected distance determined as the first distance is corrected, and
wherein the second coordinate information comprises information about a second angle between a center position of the second image and the center position of the second subject and a second corrected distance determined as the second distance is corrected.

8. The electronic device of claim 7, wherein the at least one processor is further configured to:
determines the first corrected distance and the second corrected distance based on an equation: d′=d*cos(r*Δx),
wherein d′ is a corrected distance, d is a distance between the electronic device and a subject, r is an angle between the center of an image and the subject, and Δx is a distance in a horizontal direction between the center position of the image and the center position of the subject.

9. The electronic device of claim 1, wherein the at least one processor is further configured to obtain the first image and the second image from an external image sensor electrically connected to the electronic device.

10. The electronic device of claim 1, further comprising a camera, wherein the at least one processor is further configured to:
obtain the first image and the second image through the camera; and
store the first image and the second image in the memory.

11. The electronic device of claim 10, wherein the at least one processor is further configured to:
obtain a third image different from the first image and the second image from at least one of the camera or an external image sensor electrically connected to the electronic device;
generate third subject information associated with the third image and third distance information associated with the third image;
generate third coordinate information based on the third subject information and the third distance information;
generate second plane information different from the first plane information based on the third coordinate information and the first plane information; and
store the second plane information in the memory.

12. The electronic device of claim 1, further comprising a display, wherein the at least one processor is further configured to:
display, on the display, at least one object based on the first plane information, and
wherein a foot of the at least one object is positioned on a virtual plane defined according to the first plane information.

13. The electronic device of claim 12, wherein the at least one processor displays, on the display, the virtual plane defined based on the first plane information in a grid form.

14. The electronic device of claim 1, further comprising at least one sensor, wherein the at least one processor is further configured to:
identify the first distance information and the second distance information using the at least one sensor; and
store the first distance information and the second distance information in the memory.

15. The electronic device of claim 14, wherein the at least one sensor includes at least one of a motion sensor, a radio frequency (RF) sensor, an ultra-wideband (UWB) sensor, and an ultrasonic sensor.

16. A method of augmented image generation, the method being performed by at least one processor, the method comprising:
generating first subject information associated with a first image and second subject information associated with a second image;
identifying first distance information associated with the first image and second distance information associated with the second image;
identifying first coordinate information based on the first subject information and the first distance information;
identifying second coordinate information based on the second subject information and the second distance information;
generating first plane information based on the first coordinate information and the second coordinate information; and
storing the first plane information in the memory.

17. A non-transitory computer readable medium storing one or more instructions, the one or more instructions that, when executed by at least one processor, cause the at least one processor to:
generate first subject information associated with a first image and second subject information associated with a second image;
identify first distance information associated with the first image and second distance information associated with the second image;
identify first coordinate information based on the first subject information and the first distance information;
identify second coordinate information based on the second subject information and the second distance information;
generate first plane information based on the first coordinate information and the second coordinate information; and
store the first plane information in the memory.
